(19) United States
(12) Patent Application Publication
(10) Pub. No.: US 2022/0155630 A1
(43) Pub. Date: May 19, 2022

(54) SPACER AND MANUFACTURING METHOD THEREOF, DISPLAY DEVICE AND MANUFACTURING METHOD THEREOF

(71) Applicants: Hefei BOE Display Technology Co., Ltd., Hefei (CN); BOE Technology Group Co., Ltd., Beijing (CN)

(72) Inventors: Chunpu WU, Beijing (CN); Kai WANG, Beijing (CN); Hongxiang XU, Beijing (CN); Heng ZHANG, Beijing (CN); Chenchen DI, Beijing (CN)

(21) Appl. No.: 17/359,477

(22) Filed: Jun. 25, 2021

(30) Foreign Application Priority Data
Nov. 19, 2020 (CN) 202011303309.X

(51) Int. Cl. G02F 1/1339; G02F 1/1335

(52) U.S. Cl. CPC G02F 1/13398; G02F 1/13396; G02F 1/133516; G02F 1/13394

(57) ABSTRACT

A spacer, includes: a spacer body, including a first end and a second end disposed opposite to each other, material for the spacer body being an elastic material; and a groove, provided at the first end of the spacer body, such that the first end forms a sucker under pressure in a direction from the second end. A method of manufacturing the spacer, a display device, and a method of manufacturing the display device are further provided.

### CROSS REFERENCE TO RELATED APPLICATIONS

This disclosure claims the priority of a Chinese patent application filed with National Intellectual Property Administration, P. R. C., under CN 202011303309.X, entitled “Spacer and Manufacturing method thereof, display device and Manufacturing method thereof” on Nov. 19, 2020, the entire contents of which are incorporated by reference in this disclosure.

### TECHNICAL FIELD

Embodiments of the present disclosure relate to a spacer and a manufacturing method thereof, a display device and a manufacturing method thereof.

### BACKGROUND

With high-generation lines coming into service and coming of the arrival of the TFT-LCD (thin-film transistor-liquid crystal display) flat panel era, production of large-size TFT-LCDs is increasing, and spherical spacer dispersion process is no longer used by high-generation production lines. The initial spherical spacers have been replaced by post spacers. Moreover, the post spacers have been widely used in large-size liquid crystal displays. The working principle of the poet spacers is that the post spacers with a specific height densely distributed in the non-display area of the color filter substrate resist external pressure and their own pressure to maintain a thickness of the cell during a cell-assembly process with the non-display area of the array substrate and in use of the liquid crystal display. However, during the manufacturing process and the use of the liquid crystal display, some regions in which the spacers and the array substrate contact with each other may be pressed by a force and deformed under the force, and the spacers sliding to a pixel area of the array substrate will scratch an alignment film disposed in a display area of the array substrate, which cause blue spots to occur. Moreover, the liquid crystal display has insufficient restoring force after the force disappears, the color filter substrate and the array substrate cannot return to their original position, and the black matrix cannot completely block the backlight, thus, light leaks in the display area. In addition, in a case that the liquid crystal display is placed vertically for a long time, liquid crystal molecules will accumulate toward the bottom and the corners of the display device under the gravity (especially in high temperature), resulting a thickness of the cell to get greater and abnormal colors.

### SUMMARY

At least one embodiment of the present disclosure provides a spacer, including:

a spacer body, a spacer body, comprising a first end and a second end disposed opposite to each other, material for the spacer body being an elastic material; and

a groove, provided at the first end of the spacer body, such that the first end forms a sucker under pressure in a direction from the second end.

In an embodiment of the present disclosure, a first width of the first end of the spacer body is less than a second width of the second end of the spacer body.

In an embodiment of the present disclosure, a width of the spacer body gradually decreases from the second end to the first end.

In an embodiment of the present disclosure, a height of the spacer body ranges from 3.5 μm to 3.7 μm, and a depth of the groove ranges from 0.5 μm to 1.0 μm.

In an embodiment of the present disclosure, a first width of the first end of the spacer body ranges from 15 μm to 20 μm, and an opening size of the groove ranges from 4 μm to 6 μm.

In an embodiment of the present disclosure, the material for the spacer body is a negative photoresist.

At least one embodiment of the present disclosure provides a method of manufacturing a spacer, which is applicable to manufacture the spacer as described above, the method includes:

forming an elastic material film layer; and

pattering the elastic material film layer to form a spacer.

In an embodiment of the present disclosure, material for the elastic material film layer is a negative photoresist;

patterning the elastic material film layer to form the spacer includes:

placing a mask on the elastic material film layer, the mask comprising a light-blocking area, a first light transmitting area, and a second light transmitting area, the first light transmitting area surrounding the second light transmitting area, the light-blocking area surrounding the first light transmitting area, and a first light transmittance of the first light transmitting area being greater than a second light transmittance of the second light transmitting area; and

exposing and developing the elastic material layer to obtain the spacer.

At least one embodiment of the present disclosure provides a display device, including a color filter substrate, an array substrate, and the spacer as described above;

wherein the spacer is disposed between the color filter substrate and the array substrate and on a black matrix of the color filter substrate, wherein the second end of the spacer is disposed on the color filter substrate.

In an embodiment of the present disclosure, the spacer includes a first spacer and a second spacer, and a first height of the first spacer is greater than a second height of the second spacer, the first end of the first spacer is in contact with the array substrate, and there is a gap between the first end of the second spacer and the array substrate.

In an embodiment of the present disclosure, a difference between the first height of the first spacer and the second height of the second spacer ranges from 0.65 μm to 0.8 μm.

At least one embodiment of the present disclosure provides a method of manufacturing a display device, applicable to manufacture the display device as described above, the method including:

forming an elastic material film layer on the color filter substrate;

patterning the elastic material film layer to form the spacer; and

cell-assembling the color filter substrate and the array substrate to obtain the display device.

In an embodiment of the present disclosure, the spacer includes a first spacer and a second spacer, and a first height of the first spacer is greater than a second height of the second spacer, a first end of the first spacer is in contact with the array substrate, and there is a gap between a first end of the second spacer and the array substrate; material for the elastic material layer is negative photoresist;

patterning the elastic material film layer to form the spacer includes:

placing a mask on the elastic material layer, wherein the mask includes a light-blocking area, a first light transmitting area, a second light transmitting area, a third light transmitting area, and a fourth light transmitting area, the first light transmitting area surrounds the second light transmitting area, a first light transmittance of the first light transmitting area is greater than a second light transmittance of the second light transmitting area, and the third light transmitting area surrounds the fourth light transmitting area, a third light transmittance of the third light transmitting area is greater than a fourth light transmittance of the fourth light transmitting area, the first light transmittance of the first light transmitting area is greater than the third light transmittance of the third light transmitting area, and the light-blocking area surrounds the first light transmitting area and the third light transmitting area; and

exposing and developing the elastic material film layer to obtain the spacer.

It should be understood that the above general description and the following detailed description are only exemplary and explanatory, and cannot be construed as a limit to the present disclosure.

### BRIEF DESCRIPTION OF THE DRAWINGS

The drawings herein are incorporated into the specification and constitute a part of the specification, illustrate embodiments in accordance with the disclosure, and are used together with the specification to explain the principle of the disclosure.

FIG. 1 illustrates a schematic structural view of a spacer according to an embodiment of the present disclosure;

FIG. 2 illustrates a schematic structural view of a display device according to an embodiment of the present disclosure;

FIG. 3 illustrates a flow chart of a method of manufacturing a spacer according to an embodiment of the present disclosure;

FIG. 4 illustrates an intermediate structure obtained in the process of manufacturing a spacer according to an embodiment of the present disclosure;

FIG. 5 illustrates a flowchart of a method of manufacturing a spacer according to another embodiment of the present disclosure;

FIG. 6 illustrates an intermediate structure obtained in the process of manufacturing a spacer according to another embodiment of the present disclosure;

FIG. 7 illustrates a schematic structural view of a spacer according to another embodiment of the present disclosure;

FIG. 8 illustrates a flowchart of a manufacturing method of a display device according to an embodiment of the present disclosure;

FIG. 9 illustrates an intermediate structure obtained in the process of manufacturing a display device according to an embodiment of the present disclosure;

FIG. 10 illustrates a flowchart of a method of manufacturing a display device according to another embodiment of the present disclosure; and

FIGS. 11 to 12 illustrate intermediate structures obtained in the process of manufacturing a display device according to another embodiment of the present disclosure.

### DETAILED DESCRIPTION OF THE EMBODIMENTS

The exemplary embodiments will be described in detail here, and examples thereof are illustrated in the accompanying drawings. In a case that the following description refers to the drawings, unless otherwise indicated, the same reference signs in different drawings designate the same or similar elements. The implementation manners described in the following exemplary embodiments do not represent all implementation manners consistent with the present disclosure. Rather, they are merely examples of devices and methods consistent with some aspects of the present disclosure as defined in the appended claims.

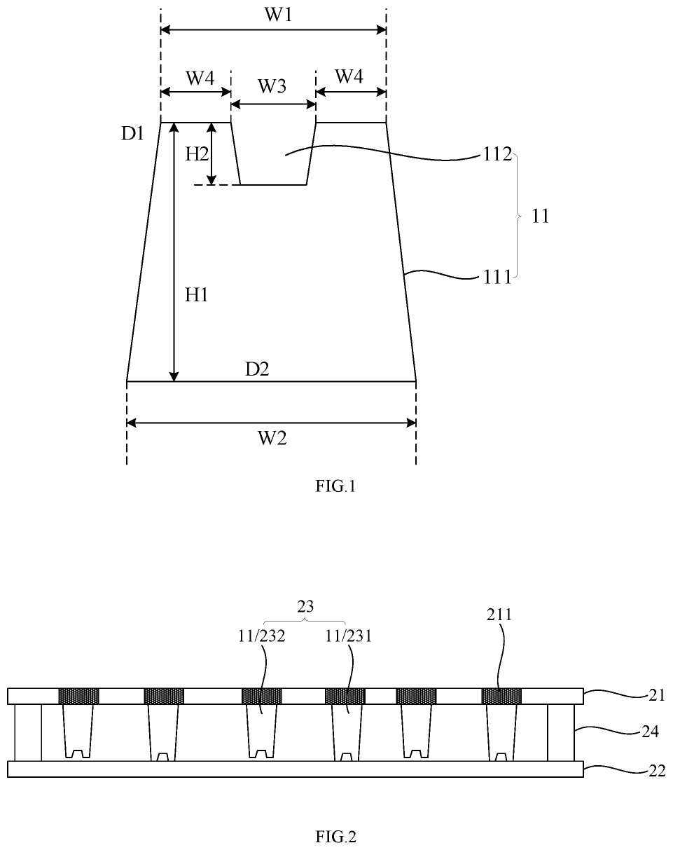

At least one embodiment of the present disclosure provides a spacer. As illustrated in FIG. 1, the spacer 11 includes a spacer body 111 and a groove 112.

As illustrated in FIG. 1, the spacer body 111 includes a first end D1 and a second end D2 disposed opposite to each other; material for the spacer body 111 is an elastic material.

The groove 112 is disposed at the first end D1 of the spacer body 111, and the first end D1 forms a sucker under a pressure in a direction from the second end D2.

In the embodiment of the present disclosure, since the material for the spacer body is elastic, and the first end of the spacer body is provided with a groove, the first end of the spacer body forms a sucker under a pressure in a direction from the second end of the spacer body. Thus, the first end of the spacer body forms a sucker during the deformation of the spacer under force, and a suction force of the sucker can prevent the spacer from sliding.

The spacer 11 according to the embodiment of the present disclosure has been briefly introduced above, and the spacer 11 according to the embodiments of the present disclosure will be described in detail hereinafter.

At least one embodiment of the present disclosure provides a spacer. As illustrated in FIG. 1, the spacer 11 includes a spacer body 111 and a groove 112.

As illustrated in FIG. 1, the spacer body 111 includes a first end D1 and a second end D2 disposed opposite to each other. Material for the spacer body 111 is an elastic material. The spacer body 111 further includes a groove 112 disposed at the first end D1 of the spacer body 111, and the first end D1 forms a sucker under pressure in a direction from the second end D2.

In an embodiment of the present disclosure, the material for the spacer body 111 is a negative photoresist. Of course, alternatively, the material for the spacer body 111 may be a positive photoresist or other elastic material.

In an embodiment of the present disclosure, a first width W1 of the first end D1 of the spacer body 11 is less than a second width W2 of the second end D2 of the spacer body 111. Moreover, a width of the spacer body 111 gradually decreases from the second end D2 to the first end D1. In this way, it can provide stable supporting.

In an embodiment of the present disclosure, a height H1 of the spacer body 111 ranges from 3.5 μm to 3.7 μm. For example, the height H1 of the spacer body 111 is 3.55 μm, 3.6 μm, or 3.7 μm.

In an embodiment of the present disclosure, a depth H2 of the groove 112 ranges from 0.5 μm to 1.0 μm. For example, the depth H2 of the groove 112 is 0.5 μm, 0.6 μm, 0.7 μm, 0.8 μm, 0.9 μm, or 1.0 μm.

In an embodiment of the present disclosure, the first width W1 of the first end D1 of the spacer body 111 ranges from 15 μm to 20 μm. For example, the first width W1 of the first end D1 of the spacer body 111 may be 15 μm, 17 μm, or 20 μm.

In an embodiment of the present disclosure, an opening size W3 of the groove 112 is 4 μm to 6 μm. For example, the opening size W3 of the groove 112 may be 4 μm, 5 μm, or 6 μm.

In an embodiment of the present disclosure, since the material for the spacer body is an elastic material, and the first end of the spacer body is provided with a groove, the first end of the spacer body forms a sucker under a pressure in a direction from the second end of the spacer. Thus, during the deformation of the spacer under pressure, the first end of the spacer body forms a sucker, and a suction force of the sucker can prevent the spacer from sliding.

At least one embodiment of the present disclosure further provides a display device. As illustrated in FIG. 2, the display device includes a color filter substrate 21, an array substrate 22, a spacer 23 and a sealant 24.

As illustrated in FIG. 2, the spacer 23 is disposed between the color filter substrate 21 and the array substrate 22 and is disposed on a black matrix 211 of the color filter substrate 21.

In an embodiment of the present disclosure, the spacer 23 includes a first spacer 231 and a second spacer 232, and a first height of the first spacer 231 is greater than a second height of the second spacer 232. A difference between the first height of the first spacer 231 and the second height of the second spacer 232 ranges from 0.65 μm to 0.8 μm. For example, the difference between the first height of the first spacer 231 and the second height of the second spacer 232 may be 0.65 μm, 0.7 μm, or 0.8 μm.

In an embodiment of the present disclosure, the first spacer 231 and the second spacer 232 are both the spacer 11 in the above-mentioned embodiment.

In an embodiment of the present disclosure, a second end D2 of the first spacer 231 is disposed on the color filter substrate 21, and a second end D2 of the second spacer 232 is disposed on the color filter substrate 21. The first end D1 of the first spacer 231 is in contact with the array substrate 22, and there is a gap between the first end D1 of the second spacer 232 and the array substrate 22.

In an embodiment of the present disclosure, the array substrate 22 may include a pixel area and a non-display area, and the first end D1 of the first spacer 231 is in contact with the non-display area of the array substrate 22, for example, the first end D1 is in contact with a gate line in the non-display area of the array substrate 22, and the gate line is disposed in the non-display area of the array substrate 22.

In an embodiment of the present disclosure, the first spacer 231 is configured to maintain a cell thickness of the display device, and the second spacer 232 is configured to protect the first spacer 231 from deforming too much and being of less restoring force.

In an embodiment of the present disclosure, the first end of the spacer body is disposed adjacent to the array substrate, and during the spacer deforms under pressure, the first end of the spacer body forms a sucker. A suction force of the sucker can prevent the spacer from sliding from the non-display area to the pixel area of the array substrate, and further, the alignment film on the array substrate can be prevented from being scratched and no blue spots occurs.

Moreover, since the first end of the spacer body is provided with a groove, even if the spacer is deformed under a force and slides from the non-display area to the pixel area of the array substrate, a contact area between the spacer and the array substrate may be reduced, and scratched area of the alignment film can be decreased and the blue spot area may be also decreased.

Moreover, in a case that the display device is placed vertically or obliquely for a long time, since the first end of the spacer body forms a sucker in a case of being applied a pressure in a direction from the second end of the spacer body, the spacer does not depart from the non-display area of the array substrate, and liquid crystal molecules do not fall downwards and accumulate at the bottom and the corners of the display device due to gravity. Thus, uneven cell thickness can be avoided.

Moreover, in a case that the display device is knocked, since the first end of the spacer body forms a sucker under a pressure in a direction from the second end of the spacer body, an offset of the spacer with respect to the array substrate can be effectively reduced, thus, the risk of Touch Mura (light leakage from touch display) is mitigated.

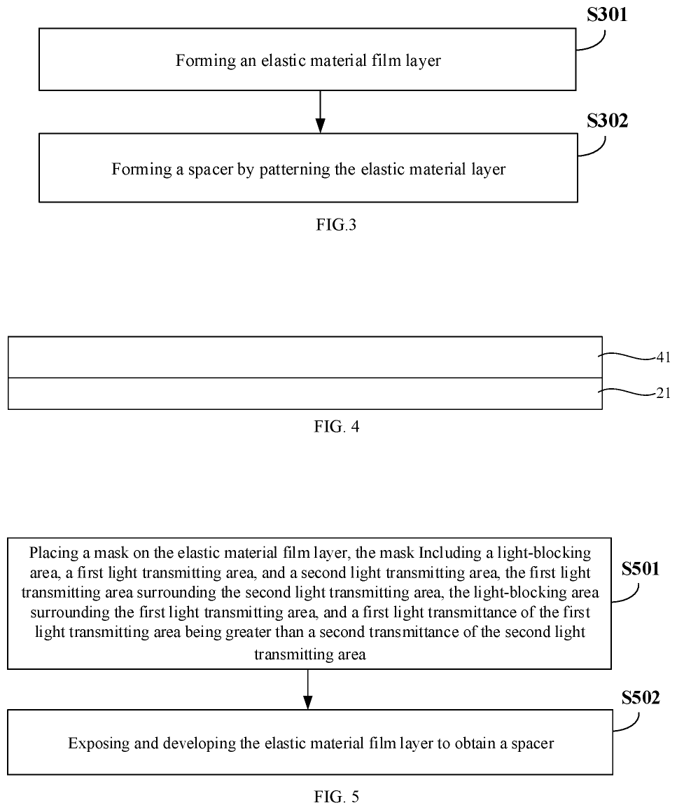

At least one embodiment of the present disclosure further provides a method of manufacturing a spacer. As illustrated in FIG. 3, the method of manufacturing a spacer includes followings:

In step S301, an elastic material film layer is formed.

In an embodiment of the present disclosure, as illustrated in FIG. 4, an elastic material film layer 41 may be formed on the color filter substrate 21. Material for the elastic material film layer 41 is a negative photoresist. In this way, a pattern of a light transmitting area on the mask may be transferred to the elastic material layer, which can protect film layers underneath from being etched away in an etching process. Finally, the elastic material film layer is removed, and then the patterns are transferred to the film layer.

In step S302, the elastic material layer is patterned to form a spacer.

In an embodiment of the present disclosure, as illustrated in FIG. 5, step S302 includes following steps S501 to S502:

In step S501, a mask is placed on the elastic material film layer. The mask includes a light-blocking area, a first light transmitting area, and a second light transmitting area. The first light transmitting area surrounds the second light transmitting area, and the light-blocking area surrounds the first light transmitting area. A first light transmittance of the first light transmitting area is greater than a second transmittance of the second light transmitting area.

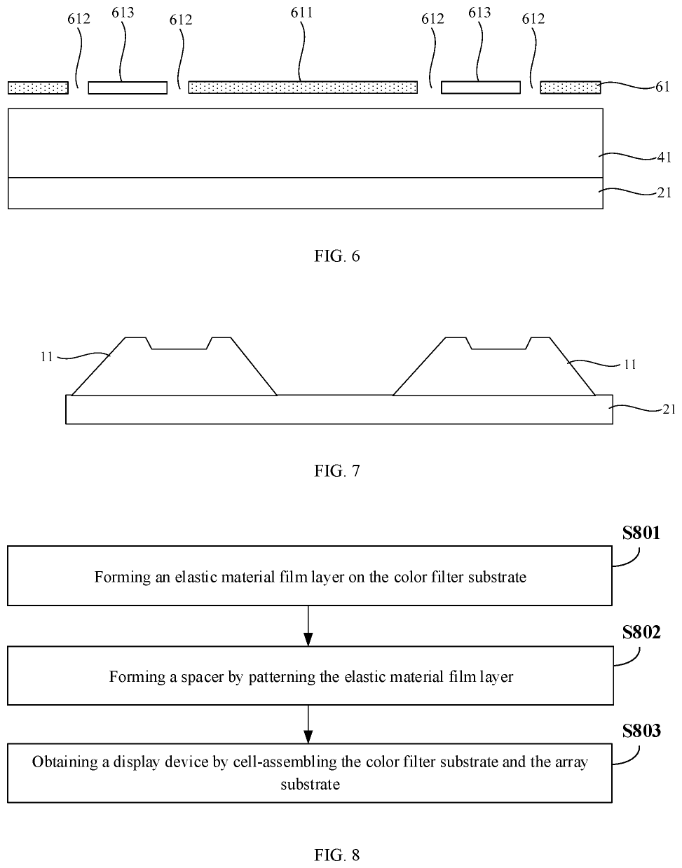

In an embodiment of the present disclosure, as illustrated in FIG. 6, a mask 61 is placed on the elastic material film layer 41. The mask 61 includes a light-blocking area 611, a first light transmitting area 612, and a second light transmitting area 613, the first light transmitting area 612 surrounds the second light transmitting area 613, the light-blocking area 611 surrounds the first light transmitting area 612, and a first light transmittance of the first light transmitting area 612 is greater than a second transmittance of the second light transmitting area 613.

In an embodiment of the present disclosure, the first light transmittance of the first light transmitting region 612 is approximate to 100%. The second light transmittance of the second light transmitting area 613 ranges from 60% to 70%, or ranges from 70% to 80%, which is not limited in the present disclosure.

In step S502, the elastic material film layer is exposed and developed to obtain a spacer.

In an embodiment of the present disclosure, the elastic material film layer 41 is first exposed as illustrated in FIG. 6, that is, the mask 61 and the elastic material layer 41 may be irradiated with ultraviolet light, and then the exposed elastic material film layer is developed by a developer. After developing the elastic material layer 41, a spacer 11 is obtained. Please refer to FIG. 7 for details. The developer may be KOH, which is not limited in the present disclosure.

In the spacer according to the embodiment of the present disclosure, since the material for the spacer body is an elastic material, and the first end of the spacer body is provided with a groove, the first end of the spacer body forms a sucker under a pressure in a direction from the second end of the spacer body. Thus, the first end of the spacer body forms a sucker in a case of deformation due to being applied a pressure, and a suction force of the sucker can prevent the spacer from sliding.

At least one embodiment of the present disclosure further provides a method of manufacturing a display device. The method of manufacturing a display device, as illustrated in FIG. 8, includes following steps S801 to S803:

In step S801, an elastic material film layer is formed on the color filter substrate.

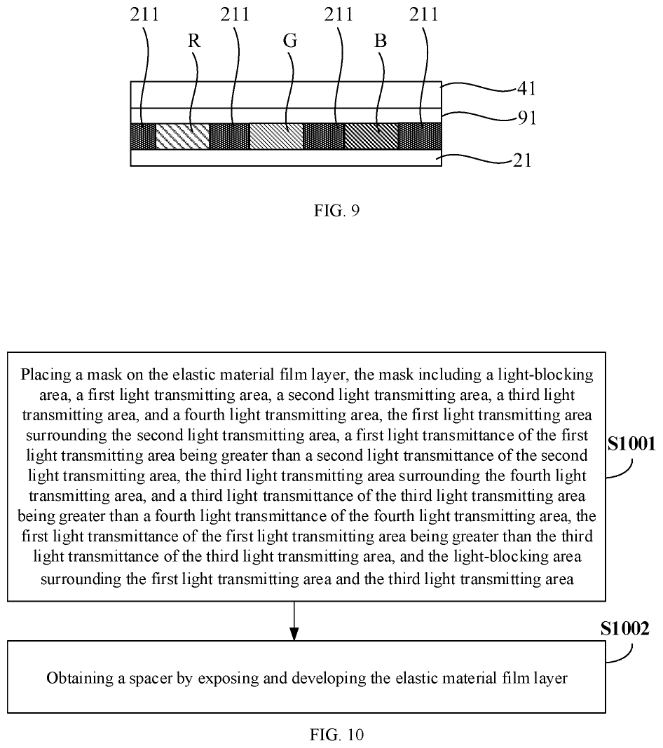

In an embodiment of the present disclosure, as illustrated in FIG. 9, the color filter substrate 21 includes a black matrix 211 and a red color filter R, a green color filter G, and a blue color filter B disposed in openings of the black matrix 211.

In an embodiment of the present disclosure, as illustrated in FIG. 9, a planarization layer 91 may be formed on the color filter substrate 21 first, and then an elastic material layer 41 may be formed on the planarization layer 91. Material for the elastic material film layer 41 is a negative optical adhesive. Material for the planarization layer 91 may be a transparent optical adhesive, which is not limited in the present disclosure.

In step S802, the elastic material film layer is patterned to form a spacer.

In an embodiment of the present disclosure, as illustrated in FIG. 10, step S802 includes following steps S1001 to S1002:

In step S1001, a mask is placed on the elastic material film layer. The mask includes a light-blocking area, a first light transmitting area, a second light transmitting area, a third light transmitting area, and a fourth light transmitting area. The first light transmitting area surrounds the second light transmitting area, a first light transmittance of the first light transmitting area is greater than a second light transmittance of the second light transmitting area, the third light transmitting area surrounds the fourth light transmitting area, and a third light transmittance of the third light transmitting area is greater than a fourth light transmittance of the fourth light transmitting area, the first light transmittance of the first light transmitting area is greater than the third light transmittance of the third light transmitting area, and the light-blocking area surrounds the first light transmitting area and the third light transmitting area.

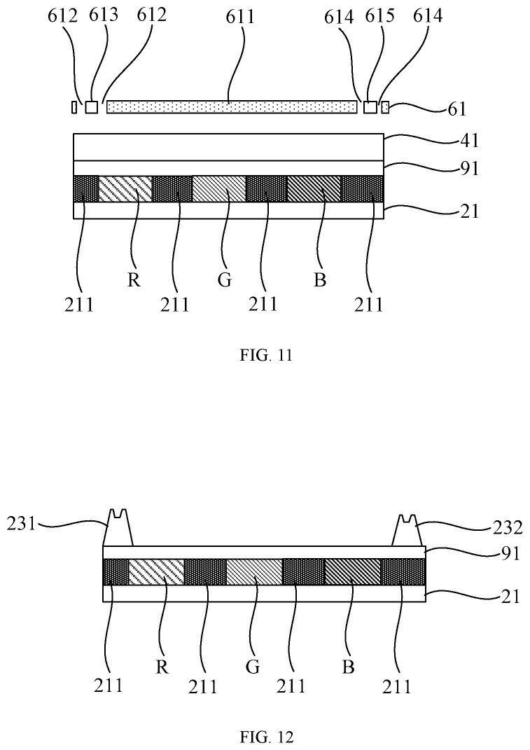

In an embodiment of the present disclosure, as illustrated in FIG. 11, a mask 61 is placed on the elastic material film layer 41. The mask 61 includes a light-blocking area 611, a first light transmitting area 612, and a second light transmitting area 613, a third light transmitting area 614 and a fourth light transmitting area 615.

In an embodiment of the present disclosure, the first light transmitting area 612 surrounds the second light transmitting area 613, and a first light transmittance of the first light transmitting area 612 is greater than a second light transmittance of the second light transmitting area 613. The first light transmittance of the first light transmitting area 612 is approximate to 100%. The second light transmittance of the second light transmitting area 613 may ranges from 70% to 80%.

In an embodiment of the present disclosure, the third light transmitting area 614 surrounds the fourth light transmitting area 615, and a third light transmittance of the third light transmitting area 614 is greater than a fourth light transmittance of the fourth light transmitting area 615. The third light transmittance of the third light transmitting area 614 may be 90%, which is not limited in the present disclosure. The fourth light transmittance of the fourth light transmitting area 615 may ranges from 60% to 70%.

In an embodiment of the present disclosure, the first light transmittance of the first light transmitting area 612 is greater than the third light transmittance of the third light transmitting area 614, and the light-blocking area 611 surrounds the first light transmitting area 612 and the third light transmitting area 614.

In step S1002, the elastic material film layer is exposed and developed to obtain a spacer.

In an embodiment of the present disclosure, the elastic material film layer 41 is first exposed as illustrated in FIG. 11, that is, the mask 61 and the elastic material layer 41 may be irradiated with ultraviolet light, and then the exposed elastic material film layer 41 is developed to obtain a first spacer 231 and a second spacer 232 as illustrated in FIG. 12. The developer may be KOH.

In an embodiment of the present disclosure, a first height of the first spacer 231 is greater than a second height of the second spacer 232. A difference between the first height of the first spacer 231 and the second height of the second spacer 232 is 0.8 micrometers.

In an embodiment of the present disclosure, both the first spacer 231 and the second spacer 232 are the spacer 11 as described in the above-mentioned embodiments.

In step S803, the color filter substrate and the array substrate are cell-assembled to obtain a display device.

In an embodiment of the present disclosure, the color filter substrate 21 and the array substrate 22 are cell-assembled to obtain a display device as illustrated in FIG. 2. The term “cell-assemble” refers to a process of bonding the color filter substrate to the array substrate so as to obtain a display device.

In an embodiment of the present disclosure, as illustrated in FIG. 2, after the color filter substrate 21 and the array substrate 22 are cell-assembled, the display device may be sealed through a frame sealant 24.

In the display device including the spacer manufactured according to the embodiment of the present disclosure, since the first end of the spacer body is disposed adjacent to the array substrate, the first end of the spacer body is deformed under a pressure and forms a sucker, which can prevent the spacer from sliding from the non-display area to the pixel area of the array substrate. Thus, the alignment film on the array substrate can be kept from being scratched and no blue spots occur.

Moreover, since the first end of the spacer body is provided with a groove, even if the spacer slides from the non-display area to the pixel area of the array substrate in a case that the spacer is deformed under a force, contact area between the spacer and the array substrate may be reduced, thus, a scratched area of the alignment film may be decreased and area of blue spots may also be reduced.

Moreover, in a case that the display device is placed vertically or obliquely for a long time, since the first end of the spacer body forms a sucker under a pressure in a direction from the second end of the spacer body, such that the spacer is not separated from and kept in contact with the non-display area of the array substrate, and liquid crystal molecules do not fall downwards and do not accumulate at the bottom and the corners due to gravity, thus, uneven cell thickness can be avoided.

Moreover, in a case that the display device is knocked, since the first end of the spacer body forms a sucker under a pressure in a direction from the second end of the spacer, such that an offset of the spacer with respect to the array substrate may be reduced and a risk of Touch Mura (light leakage from touch display) can be mitigated.

It should be noted that the display device in this embodiment may be any product or component with display function, such as an electronic paper, a mobile phone, a tablet computer, a television, a notebook computer, a digital photo frame, a navigator, and etc.

Forming processes used in the above manufacturing method may include, for example, film forming processes such as deposition and sputtering, and patterning processes such as etching.

It should be noted that in the drawings, sizes of layers and regions may be exaggerated for clarity of illustration. It should further be understood that in a case that an element or layer is referred to as being “on” another element or layer, it can be directly on the other element or at least one intervening element or layer may be present. In addition, it should be understood that in a case that an element or layer is referred to as being “under” another element or layer, it can be directly under the other element, or there may be at least one intervening layer or element. In addition, it should be further understood that in a case that a layer or element is referred to as being “between” two layers or two elements, it can be the only layer between the two layers or two elements, or more than one intervening layer or may also be present. Similar reference signs designate similar elements throughout the specification.

In the present disclosure, the terms “first” and “second” are only used for descriptive purposes, and cannot be understood as indicating or implying relative importance. The term “plurality” refers to two or more, unless specifically defined otherwise.

One of ordinary skill in the art will easily conceive of other embodiments of the present disclosure after considering the specification and practicing the disclosure disclosed herein. The present disclosure is intended to cover any variations, applications, or modifications of the present disclosure. These variations, applications, or modifications follow the general principles of the present disclosure and include common knowledge or conventional technical means in the technical field that are not disclosed in the present disclosure. The description and the embodiments should be regarded as exemplary only, and the true scope and spirit of the present disclosure are limited by the appended claims.

1. A spacer, comprising:
a spacer body, comprising a first end and a second end disposed opposite to each other, material for the spacer body being an elastic material; and
a groove, provided at the first end of the spacer body, such that the first end forms a sucker under pressure in a direction from the second end.

2. The spacer according to claim 1, wherein a first width of the first end of the spacer body is less than a second width of the second end of the spacer body.

3. The spacer according to claim 2, wherein a width of the spacer body gradually decreases from the second end to the first end.

4. The spacer according to claim 1, wherein a height of the spacer body ranges from 3.5 μm to 3.7 μm, and a depth of the groove ranges from 0.5 μm to 1.0 μm.

5. The spacer according to claim 1, wherein a first width of the first end of the spacer body ranges from 15 μm to 20 μm, and an opening size of the groove ranges from 4 μm to 6 μm.

6. The spacer according to claim 1, wherein the material for the spacer body is a negative photoresist.

7. A method of manufacturing a spacer, which is applicable to manufacture the spacer according to claim 1, the method comprising:
forming an elastic material film layer; and
pattering the elastic material film layer to form a spacer.

8. The method according to claim 7, wherein material for the elastic material film layer is a negative photoresist;
patterning the elastic material film layer to form the spacer comprises:
placing a mask on the elastic material film layer, the mask comprising a light-blocking area, a first light transmitting area, and a second light transmitting area, the first light transmitting area surrounding the second light transmitting area, the light-blocking area surrounding the first light transmitting area, and a light transmittance of the first light transmitting area being greater than a light transmittance of the second light transmitting area; and
exposing and developing the elastic material layer to obtain the spacer.

9. A display device, comprising: a color filter substrate, an array substrate, and the spacer according to claim 1; wherein
the spacer is disposed between the color filter substrate and the array substrate and on a black matrix of the color filter substrate, wherein the second end of the spacer is disposed on the color filter substrate.

10. The display device according to claim 9, wherein the spacer comprises a first spacer and a second spacer, and a first height of the first spacer is greater than a second height of the second spacer, the first end of the first spacer is in contact with the array substrate, and there is a gap between the first end of the second spacer and the array substrate.

11. The display device according to claim 10, wherein a difference between the first height of the first spacer and the second height of the second spacer ranges from 0.65 μm to 0.8 μm.

12. A method of manufacturing a display device, applicable to manufacture the display device according to claim 9, the method comprising:
forming an elastic material film layer on the color filter substrate;
patterning the elastic material film layer to form the spacer; and
cell-assembling the color filter substrate and the array substrate to obtain the display device.

13. The method according to claim 12, wherein the spacer comprises a first spacer and a second spacer, and a first height of the first spacer is greater than a second height of the second spacer, a first end of the first spacer is in contact with the array substrate, and there is a gap between a first end of the second spacer and the array substrate; material for the elastic material film layer is negative photoresist;
patterning the elastic material film layer to form the spacer comprises:
placing a mask on the elastic material layer, wherein the mask comprises a light-blocking area, a first light transmitting area, a second light transmitting area, a third light transmitting area, and a fourth light transmitting area, the first light transmitting area surrounds the second light transmitting area, a first light transmittance of the first light transmitting area is greater than a second light transmittance of the second light transmitting area, and the third light transmitting area surrounds the fourth light transmitting area, a third light transmittance of the third light transmitting area is greater than a fourth light transmittance of the fourth light transmitting area, the first light transmittance of the first light transmitting area is greater than the third light transmittance of the third light transmitting area, and the light-blocking area surrounds the first light transmitting area and the third light transmitting area; and
exposing and developing the elastic material film layer to obtain the spacer.
